(19) United States
(12) Patent Application Publication
(10) Pub. No.: US 2025/0200367 A1
(43) Pub. Date: Jun. 19, 2025

(54) METHOD FOR OPTIMIZING AI ACCELERATOR AND AI ACCELERATOR

(71) Applicants: Shenzhen Institute for Advanced Study, UESTC, Shenzhen (CN); i4AI Ltd, London (GB); Shenzhen Empyrean Technology Co., Ltd., Shenzhen (CN)

(72) Inventors: Yuan YAN, Shenzhen (CN); Jiang XIAO, Shenzhen (CN); Sicheng HE, Shenzhen (CN); Feng SUN, Shenzhen (CN); Yun LI, Shenzhen (CN); Bin CAO, Shenzhen (CN); Zhun FAN, Shenzhen (CN); Lanrong ZOU, Shenzhen (CN); Pengfei ZHENG, Shenzhen (CN)

(73) Assignees: Shenzhen Institute for Advanced Study, UESTC, Shenzhen (CN); i4AI Ltd, London (GB); Shenzhen Empyrean Technology Co., Ltd., Shenzhen (CN)

(21) Appl. No.: 19/026,584

(22) Filed: Jan. 17, 2025

Related U.S. Application Data
(63) Continuation of application No. PCT/CN2024/098529, filed on Jun. 12, 2024.

(30) Foreign Application Priority Data
Dec. 19, 2023 (CN) 202311744044.0

(51) Int. Cl. G06N 3/08

(52) U.S. Cl. CPC G06N 3/08

(57) ABSTRACT

The present invention discloses an optimizing method for an AI accelerator and an AI accelerator. The optimizing method optimizes the AI accelerator through obtaining target neural network architecture by genetic programming, and includes: preparing required raw data, removing abnormal data, annotating based on different data types to obtain annotated data, and selecting part of the annotated data as a training set; determining search space of genetic programming, defining function set and terminal set of genetic programming, and performing preprocessing, extracting features, concatenating features, regressing and result outputting on the annotated data; defining fitness function used in genetic programming to search for optimal individuals; and the training set performing to search for obtaining the target neural network architecture. The present invention addresses the issues of interpretability and understandability in traditional neural network generation by leveraging the encoding capabilities of genetic programming.

### FIELD OF THE INVENTION

The present invention relates to the field of AI accelerator technology, particularly to an optimizing method for an AI accelerator and an AI accelerator.

### DESCRIPTION OF THE RELATED ART

In recent years, supported by the accumulation of massive data and increasingly sophisticated computing power, deep learning (DL) has achieved significant success in fields such as image processing, text understanding, and recommendation systems. Among them, neural networks (NN) can automatically extract and process a large number of features, often achieving better performance. Currently, artificial intelligence (AI) using various neural network models has been widely applied in various industries. Due to the large amount of data and computing power required by neural networks, it is often necessary to use dedicated AI accelerators to process tasks. AI accelerators are a type of specialized hardware accelerator or computer system designed to accelerate AI applications. However, when applying deep learning to a new research task, AI accelerators typically rely on past experience to complete the design of neural network models by manual debugging. Furthermore, as the size of the model used increases, the search space for all weight parameters and feature parameters will grow exponentially, leading to a potentially exponential increase in the time required to debug parameters. Such AI accelerator design methods can consume a lot of time for researchers. The efficiency will be significantly improved if the work in this aspect is automated.

Neural architecture search (NAS) is a technology specifically researched in AI accelerators that aims to automate the design of high-performance deep neural network architectures without manual debugging. It does not require users to have extensive expert experience and has garnered widespread attention due to its ability to automate the generation of neural networks by replacing human design of neural network hyperparameters. NAS can reduce the labor-intensive work of researchers, allowing them to focus their attention and efforts on other more meaningful research. At the same time, relevant studies have proven that the performance of neural networks searched by NAS is superior to that of manually designed network structures.

Currently, research on neural network architecture search is mainly divided into three directions: search space, search strategy, and evaluation strategy, and the search strategy method has received the most attention. However, current neural network architecture search methods face the problem of consuming a large amount of computation time. Moreover, this data-driven pure black box method also makes the generated neural network lack interpretability, further limiting its application in real life. Inspired by different intelligent behaviors in biological systems, evolutionary algorithms are used to mimic these behaviors in the form of algorithms to solve optimization problems in mathematics and engineering. Among them, the genetic algorithm (GA) based on Darwin's theory of evolution has been proven to be effective in solving optimization problems and is widely used. This algorithm uses selection, crossover, and mutation operators to make the feasible solutions of the population converge to the optimal solution. With continuous research, the particle swarm optimization algorithm (PSO), Ant Colony Optimization (ACO), and other algorithms have been designed and proposed, and have been proven effective in various practical applications. Although evolutionary algorithms used in AI accelerators can often find the global optimal solution in the search space and are suitable for both continuous and discrete problems, they also have significant drawbacks, such as long execution time and high computational cost.

The inventors have found that there are at least the following problems in the prior art, in the process of implementing the present invention.

Existing evolution algorithms of AI accelerators are time-consuming and computationally expensive. It is difficult to adapt to the developing needs of AI accelerators, and further optimization and improvement are urgently needed.

### SUMMARY OF THE INVENTION

The objective of this invention is to provide an optimizing method for an AI accelerator and an AI accelerator, to address the technical problems existing in the prior art, such as the long-time consumption and high computational cost of evolution algorithms of the AI accelerator, which is difficult to adapt to the developing needs of AI accelerators and urgently needs further optimization and improvement. The technical effects of the preferred technical solution among the various technical solutions provided in the present invention are described in detail as follows.

To fulfill the above objective, the present invention provides the following technical solution:

The present invention provides an optimizing method for an AI accelerator, characterized by optimizing the AI accelerator through obtaining target neural network architecture by genetic programming, including the following steps:
S10, preparing required raw data based on a target problem, removing abnormal data from the raw data, annotating based on different data types to obtain annotated data, and selecting part of the annotated data as a training set;
S20, determining search space of genetic programming, defining function set and terminal set of genetic programming, and performing preprocessing, extracting features, concatenating features, regressing and result outputting on the annotated data;
S30, defining fitness function used in genetic programming to search for optimal individuals; and
S40, based on the function set, terminal set, and fitness function, the training set performing population initialization, fitness evaluation, genetic operation execution, and genetic termination condition judgment, to search for obtaining the target neural network architecture;
wherein in the step S20, the genetic programming employs a tree structure for neural network architecture search, the tree structure defines input and output of each layer in the genetic programming, and defines order of different layers, input and output relationships between different layers, and overall input and output formats in the neural network architecture; the function set includes different functional layers of the tree structure, each corresponding to a different function and including a preset number of unit; and the terminal set defines parameters of different functional layers, ensuring that the input and output types of each functional layer match each other and meet algorithm requirements of the genetic programming; and
wherein the genetic programming performs elite selection and acquired inheritance based on the fitness of each individual.

In one embodiment, the functional layer includes an input layer, a preprocessing layer, a feature extraction layer, a feature concatenation layer, and an output layer; the input layer is used to input raw data, the preprocessing layer is used to preprocess the type of the raw data, the feature extraction layer extracts features of the raw data through a feature extraction network, the feature concatenation layer is used to concatenate different features extracted by the feature extraction layer, and the output layer returns output results based on the features extracted by the feature extraction layer.

In one embodiment, the step S40 comprises the following steps:
S41, randomly generating an initial population consisting of multiple individuals based on the search space, the function set, and the terminal set, and using the fitness function to evaluate each individual;
S42, performing two genetic operations including rewrite and mutation on each individual in the initial population, and to obtain a new population for a next generation, evaluating each individual in a new population using the fitness function;
S43, determining whether the new population satisfies the genetic termination condition; if so, executing S44; otherwise, executing S42; and
S44, terminating evolutionary learning process, returning a best individual as the optimal result of the search, and obtaining the target neural network architecture.

In one embodiment, the optimizing method is based on GPU computation, and comprises the following steps:
S100, letting gen=0;
S200, generating the initial population X_{gen}={x₁, x₂, . . . , xₙ} on the GPU using “curand” command;
S300, gen=gen+1;
S400, conducting a neural network simulation for each generated individual and calculating the fitness F_{gen}={f₁, f₂, . . . , fₙ};
S500, waiting for all threads to synchronize, and performing genetic programming operations based on the fitness of each individual;
S600, selecting a neural network with the highest fitness, training it using BP backpropagation and Adam optimizer, and obtaining Chromₑₗᵢₜₑ;
S700, the generated threads performing genetic programming operations on the population to obtain the population X′;
S800, inserting Chromₑₗᵢₜₑ to X′ to obtain a new population X′_{gen}; and
S900, returning to step S300 until meeting the genetic termination condition, and outputting the neural network with the highest fitness as the target neural network architecture.

In one embodiment, the optimizing method uses a tree-like parameter server structure for parameter aggregation, each parameter server receives parameters of its child nodes and performs aggregation the tree-like parameter server structure; when all the data is aggregated to a root node, the root node performs gradient descent operation and updates model parameters of the target neural network architecture; and the updated model parameters are distributed to each parameter server.

In one embodiment, the optimizing method further optimizes dataset size and batch size of the target neural network architecture, and comprises the following steps:
S1000, each working node calculating dataset processing efficiency coefficient pᵢ^{j} based on its own computation time and uploading to a parameter server that serves as its parent node;
S2000, each parameter server calculating the sum of values of pᵢ^{j} uploaded by its child nodes until the root node completing the calculation;
S3000, the root node sums the processing efficiency coefficients pᵢ^{j} for each dataset to obtain the dataset processing efficiency parameter Σᵢ₌₁ⁿpᵢ^{j} and distribute it to its child nodes layer by layer, and calculating a dataset starting point for each child node; and the child nodes of the root node performing the same operation until the parameter servers at each layer completing the corresponding operation; and
S4000, each parameter server receiving the dataset starting point of the next round and dataset processing efficiency parameter Σᵢ₌₁ⁿpᵢ^{j}, calculating the batch size bᵢ^{j+1}=pᵢ^{j}/Σᵢ₌₁ⁿpᵢ^{j} and an end point of the dataset; wherein dᵢ^{j} is the proportion of the dataset size of the parameter server i in the jth round of training, bᵢ^{j} is the proportion of the batch size of the parameter server i in the jth round of training, tᵢ^{j} is the time of the parameter server i in the jth round of training, pᵢ^{j}=dᵢ^{j}/tᵢ^{j}, and pᵢ^{j} is the defined dataset processing efficiency coefficient.

In one embodiment, the optimizing method optimizes the computational performance of the parameter servers, and the optimizing method comprises: taking the dataset size of each parameter server as the dependent variable, the working time and idle waiting time of each parameter server as the fitness function value, evaluating the performance of each parameter server, and optimizing the workload of each parameter server based on the performance evaluation results using an acquired genetic algorithm.

The present invention provides an AI accelerator, which is obtained by the above-mentioned optimizing method for the AI accelerator.

Implementation of a technical solution of the above technical solutions of the present invention provides the following advantages of efficacy effects:

The present invention addresses the issues of interpretability and understandability in traditional neural network generation by leveraging the encoding capabilities of genetic programming. It also utilizes the optimization performance of genetic programming as an evolutionary algorithm to search for the optimal weight and feature precision in the search space of different weight precisions and feature precisions at each layer, resulting in a neural network architecture with optimal weight and feature precision, thereby reducing computational costs.

### BRIEF DESCRIPTION OF THE DRAWINGS

To more clearly expound the technical solution of embodiment of the present invention, a brief description will be provided below for the drawings that are necessary for the illustration of the embodiments. It is appreciated that the drawings described below show only some of the embodiments of the present invention, and those having ordinary skill in the art may envisage other drawings based on the attached drawings, without creative endeavor. In the drawings:

FIG. 1 is a flowchart of an optimizing method for and AI accelerator according to a first embodiment of the present invention;

FIG. 2 is a detailed flowchart of step S40 in FIG. 1;

FIG. 3 is a flowchart of GPU computation process for the optimizing method for the AI accelerator according to the first embodiment of the present invention;

FIG. 4 is a schematic diagram of GPU computation using one-dimensional array and two-dimensional array according to a first embodiment of the invention;

FIG. 5 is a schematic diagram of GPU computation using one-dimensional and two-dimensional arrays according to a second embodiment of the present invention;

FIG. 6 is a schematic diagram of GPU computing data transmission according to the first embodiment of the present invention;

FIG. 7 is a schematic diagram of parameter aggregation for the optimizing method for the AI accelerator according to the first embodiment of the present invention;

FIG. 8 is a flowchart of optimizing process of dataset size and batch size for the target neural network architecture according to the first embodiment of the present invention; and

FIG. 9 is a schematic diagram of the dataset size and batch size optimization of the target neural network architecture according to the first embodiment of the present invention.

### DETAILED DESCRIPTION OF PREFERRED EMBODIMENTS OF THE INVENTION

To better expound the objectives, the technical solution, and the advantages of the application, description of various illustrative embodiments will be provided below, with reference to corresponding drawings. The drawings form a part of the illustrative embodiments and provide illustration for various illustrative embodiments that are adopted to realize the present invention. Unless otherwise indicated, identical figures used through the various drawings designate the same or similar elements. The ways of implementation described with the following illustrative embodiments do not represent all the embodiments that are consistent with the disclosure. It is noted that they are only provided as examples that illustrate processes, methods, and devices in accord with some of the aspects defined, in detail, in the appended claims and disclosed in the present invention, and other feasible embodiments may also be available, and modifications with respect to the structures and functions involved in the embodiments listed in the disclosure may be made without departing from the scope and essence of the present invention.

In the description of the present invention, it is noted that terms, such as “central”, “longitudinal”, and “transverse”, are used to indicate directional or positional relationships interpreted on the basis of the illustrations of the drawings and are applied to ease the description of the present invention and to simplify the illustration thereof, and are not intended to indicate or imply a designated element must be of a specific direction, or must be structured and operated in a specific direction. Terms, such as “first” and “second”, are adopted only for the purposes of description and should not be interpreted as indicating or implying relative importance or implicitly suggesting the quantity of a technical feature indicated thereby. Terms, such as “plurality”, bear meaning of having a quantity of two or more than two. Terms, such as “interconnect” and “connect”, should be interpreted in a broad sense, such as being fixedly connected, detachably connected, integrally connected, mechanically connected, electrically connected, in communication connection, directly connected, and indirectly connected through an intermediate medium, and may be regarded as communication between interiors of two elements or an interacting relationship of two elements. Terms, such as “and/or”, include any and all combinations of one or multiple ones of listed items. For those having ordinary skill in the field, the specific meaning of the above-named terms can be appreciated from the context of the present invention based on specific situations.

To explain the technical solution provided in the present invention, in the following, description is made with respect to specific embodiments, yet only the parts that are associated with the implementation of the present invention are illustrated.

### Embodiment 1

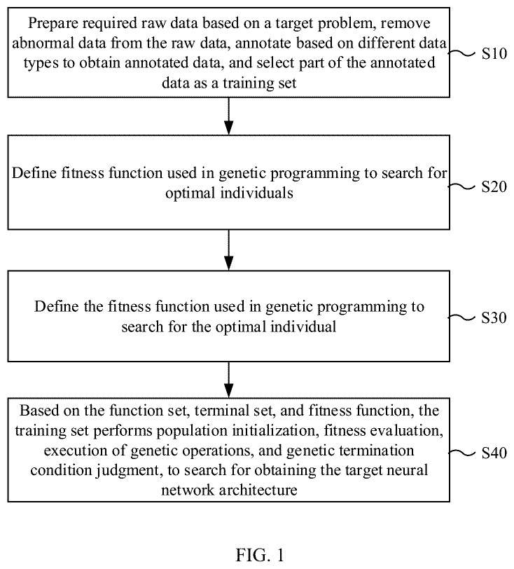

As shown in FIG. 1, the present invention provides an optimizing method for an AI accelerator, which optimizes the AI accelerator by obtaining the target neural network architecture through genetic programming, and includes the following steps. S10, prepare required raw data based on a target problem, remove abnormal data from the raw data, annotate based on different data types to obtain annotated data, and select part of the annotated data as a training set. Manual or computer programs can be used to screen out data samples that do not meet the requirements, such as data that is damaged, lost, etc. This type of data is considered abnormal data. Data annotation can use common data annotation methods for different data types. Taking image data as an example, the image data is matched with the corresponding description, and the information in the image data is annotated, etc. Annotated data not included in the training set is in a test set, which can be used to evaluate the performance of the target neural network architecture, facilitating further optimization of the target neural network architecture. S20, determine search space for genetic programming, define function set and terminal set for genetic programming, and perform preprocessing, feature extraction, feature concatenation, regression, and result output on the annotated data. S30, define fitness function used in genetic programming to search for optimal individuals. The fitness function draws inspiration from the theory of Lamarckian evolution, which addresses the slow convergence problem of genetic programming, and designing requirements meet the needs of actual tasks. For example, in classification tasks, the accuracy function is used as the fitness function for guiding the process of network architecture search. Through the fitness function, individuals with higher fitness can inherit more genes to a next generation, effectively reducing computational cost. S40, based on the function set, terminal set, and fitness function, the training set performs population initialization, fitness evaluation, execution of genetic operations, and genetic termination condition judgment, respectively, to search for obtaining the target neural network architecture. The genetic termination condition is generally the computational cost, such as the number of genetic iterations, the accuracy requirement, precision requirement, etc., which can be set according to the usage scenario and task changes. The AI accelerator of the present invention solves the problems of the unexplainability and incomprehensibility of neural network generation in AI accelerators through the encoding capability of genetic programming, and utilizes the optimization performance of genetic programming as an evolutionary algorithm to effectively reduce the computational time in AI accelerators. In the search space of different weight accuracies and feature accuracies at each layer, a neural network architecture with optimal weight and feature accuracy is searched for, reducing the computational cost of the AI accelerator.

Optionally, in step S20, genetic programming uses a tree structure to perform neural network architecture search. The tree structure defines input and output of each layer in genetic programming, thus enabling compatibility with inputs and outputs in different data types. The tree structure also defines an order of different layers in the neural network architecture, the input and output relationships between different layers, and the overall input and output formats.

Optionally, in step S20, the function set includes different functional layers of the tree structure, each functional layer corresponding to different functions, and including a set number of units. The number of units is fixed or non-fixed, which can be designed according to specific tasks. The functional layers include an input layer, a preprocessing layer, a feature extraction layer, a feature concatenation layer, and an output layer. The input layer is used to input raw data. The preprocessing layer is used to preprocess the type of the raw data, for example, image data can be subjected to grayscale transformation, etc. The feature extraction layer extracts the features of the raw data through a feature extraction network. The feature concatenation layer concatenates different features extracted by the feature extraction layer. The output layer returns output results based on the features extracted by the feature extraction layer, or it can also return a specific type of result. In step S20, the terminal set defines the parameters of different functional layers, such as the input layer defines the size of the image, the preprocessing layer defines the image preprocessing method and preprocessing parameters, the feature extraction layer defines the network parameters used, etc., so that the input and output types of each functional layer match each other and meet the requirements of the genetic programming algorithm.

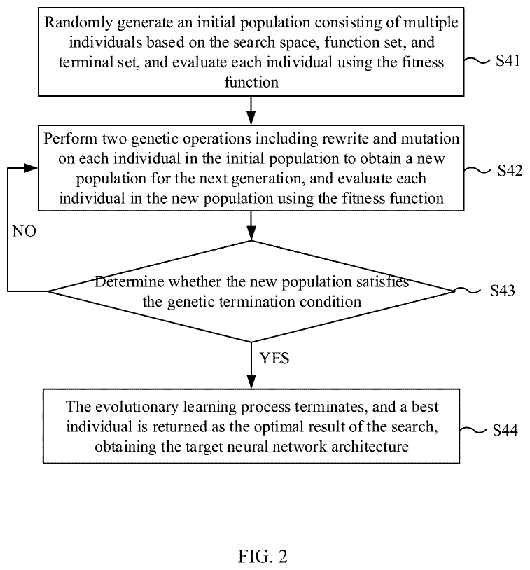

Optionally, as shown in FIG. 2, step S40 specifically includes the following steps. S41, randomly generate an initial population consisting of multiple individuals based on the search space, function set, and terminal set, and evaluate each individual using the fitness function. S42, perform two genetic operations including rewrite and mutation on each individual in the initial population to obtain a new population for the next generation, and evaluate each individual in the new population using the fitness function. Rewrite and mutation are used to alter nodes or branches of the tree to search for better solutions. The rewrite operation generates two offspring individuals from two randomly selected parent individuals, that is, the structure of the individual with a better fitness function value is written to the individual with a worse fitness function value according to a certain proportion, so as to generate a new individual. The mutation operation generates an offspring individual from a parent individual randomly selected based on fitness. After randomly selecting a mutation node on the parent individual, the subtree at the node is deleted, and then a new subtree is generated using a growing method similar to that used to generate the initial individual. S43, determine whether the new population satisfies the genetic termination condition. If so, execute S44; otherwise, return to execute S42. S44, the evolutionary learning process terminates, and a best individual is returned as the optimal result of the search, obtaining the target neural network architecture.

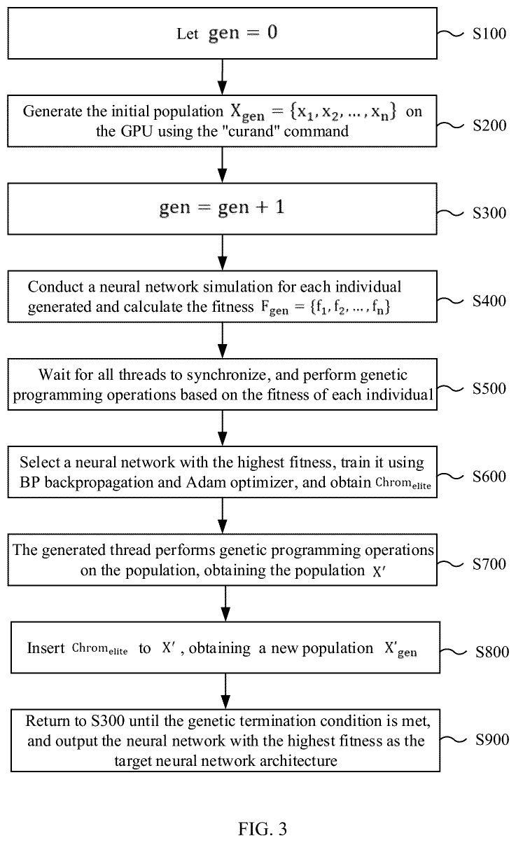

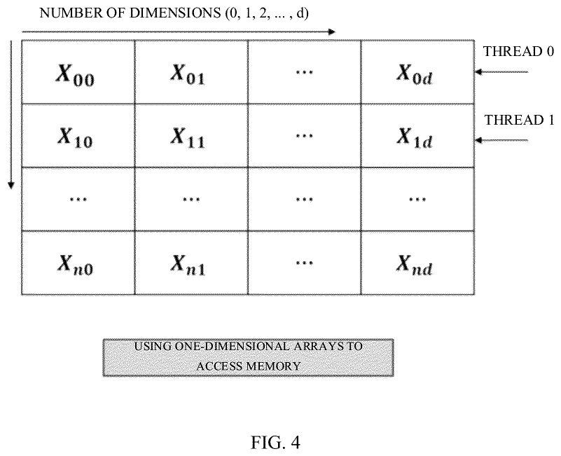

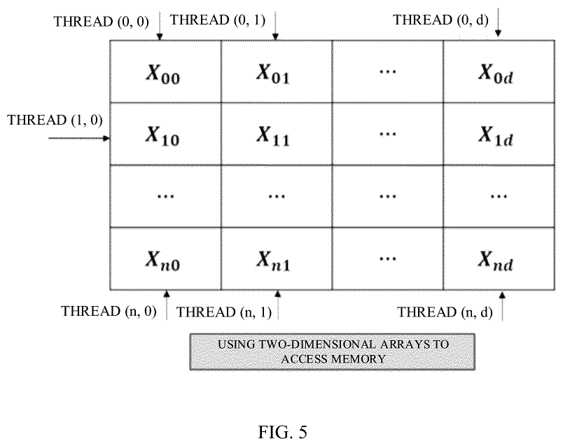

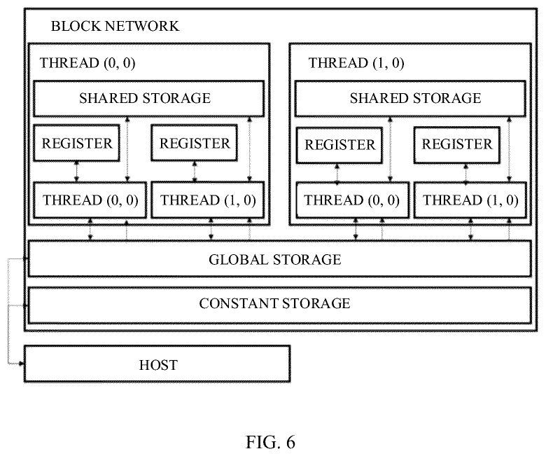

Optionally, the search method is computed based on GPU. Due to the large number of feasible solutions in the evolutionary algorithm, and the evolution of each feasible solution can be processed in parallel in different threads, it is suitable for running on GPU. Switching from the computing framework of CPU+GPU to pure GPU computing framework greatly reduces the latency caused by end-to-end communication and data transmission, which can significantly improve the speed of automated neural network design and design better neural networks. As shown in FIG. 3, computing based on GPU specifically includes the following steps. S100, let gen=0. S200, generate the initial population X_{gen}={x₁, x₂, . . . , xₙ} on the GPU using the “curand” command. S300, gen=gen+1. S400, conduct a neural network simulation for each individual generated and calculate the fitness F_{gen}={f₁, f₂, . . . , fₙ}. S500, wait for all threads to synchronize, and perform genetic programming operations based on the fitness of each individual. S600, select a neural network with the highest fitness, train it using BP backpropagation and Adam optimizer, and obtain Chromₑₗᵢₜₑ. S700, the generated thread performs genetic programming operations on the population, obtaining the population X′. S800, insert Chromₑₗᵢₜₑ to X′, obtaining a new population X′_{gen}. S900, return to step S300 until the genetic termination condition is met, and output the neural network with the highest fitness as the target neural network architecture. In the embodiment, in order to further improve the calculation speed, it is also possible to perform GPU internal optimization, using ‘multi-stream’, ‘merge memory access’ (as shown in FIG. 4 and FIG. 5), ‘shared memory’ (as shown in FIG. 5) and other methods to further improve the efficiency of parallel computing and reduce the time spent on accessing global memory. On one hand, from using one-dimensional arrays to access memory to using two-dimensional arrays to access memory can effectively reduce the number of global memory reads. On the other hand, as shown in FIG. 6, CUDA uses three vectors to organize threads into three different levels: threads, thread blocks, and block grids. Each thread has a unique thread number, and each thread has a small capacity but fast private register. Each thread block has a shared memory, which is visible to all threads in the block. All threads in the block grid can read and write the same global memory, and read a constant memory for read-only. Considering that when updating velocity and position of particles, all particles need to use the global optimal position information, so the global optimal position can be placed in the shared memory. It benefits that it does not need to repeatedly read the global optimal position information, thereby further improving the calculation speed.

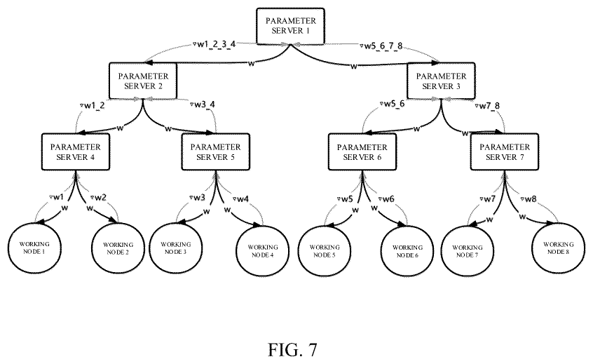

Optionally, the optimizing method adopts a tree-structured parameter server architecture for parameter aggregation. In the tree-structured parameter server architecture, each parameter server receives the parameters from its child nodes and aggregates them. When all data is aggregated to the root node, the root node performs gradient descent and updates the model parameters of the target neural network architecture. Finally, the updated model parameters are distributed to each parameter server. As shown in FIG. 7, ∇wi represents a gradient set calculated by the parameter server i, and ∇wi_j represents the result of aggregating the gradients calculated by the working nodes i and j. Using a gradient-based algorithm, the model parameters of the target neural network architecture can be realized at a local optimal solution, further saving computational costs. Using a tree-structured parameter server architecture to replace the traditional fully connected parameter server topology for parameter aggregation can reduce the number of communication times from O(n²) to O(n) in order of magnitude. In large-scale distributed systems, it can effectively reduce the number of communication times, thereby improving energy efficiency.

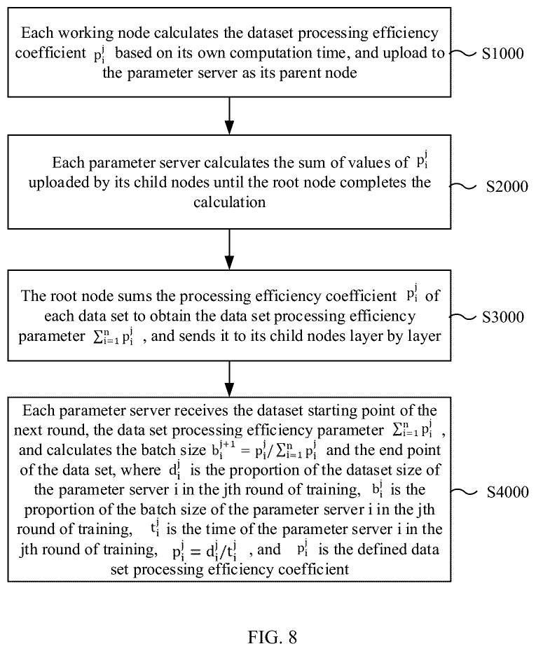

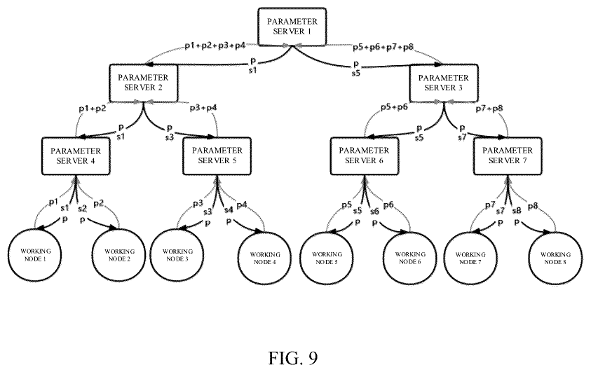

Optionally, as shown in FIG. 8, the optimizing method also optimizes dataset size and batch size of the target neural network architecture and includes the following steps. S1000, each working node calculates the dataset processing efficiency coefficient pᵢ^{j} based on its own computation time, and upload to the parameter server as its parent node. S2000, each parameter server calculates the sum of values of pᵢ^{j} uploaded by its child nodes until the root node completes the calculation. S3000, the root node sums the processing efficiency coefficient pᵢ^{j} of each data set to obtain the data set processing efficiency parameter Σᵢ₌₁ⁿpᵢ^{j}, and sends it to its child nodes layer by layer. At the same time, a dataset starting point for each child node is calculated. The child nodes of the root node perform the same operation until the parameter server of each layer completes the corresponding operation. S4000, each parameter server receives the dataset starting point of the next round, the data set processing efficiency parameter Σᵢ₌₁ⁿpᵢ^{j}, and calculates the batch size bᵢ^{j+1}=pᵢ^{j}/Σᵢ₌₁ⁿpᵢ^{j} and the end point of the data set, where dᵢ^{j} is the proportion of the dataset size of the parameter server i in the jth round of training, bᵢ^{j} is the proportion of the batch size of the parameter server i in the jth round of training, tᵢ^{j} is the time of the parameter server i in the jth round of training, pᵢ^{j}=dᵢ^{j}/tᵢ^{j}, and pᵢ^{j} is the defined data set processing efficiency coefficient. As shown in FIG. 9, Pi represents the calculated processing efficiency coefficient of the working node i, P is the sum of the efficiency coefficients Pi of all the working nodes, and Si represents the dataset starting point occupied by the node i in the next round of training. According to the data sent by the parameter server 2 and 3, the parameter server 1 can get the dataset starting position of all the child nodes of the parameter server 2 is at S1=0, and the dataset starting position of all the child nodes of the parameter server 3 is at S3=0+(p5+p6+p7+p8)/p, and the calculation of each parameter server is like this. Similarly, each parameter server i finally obtains its dataset starting point Si and P in the next round, so as to calculate the batch size and an end point of the data set according to the formula.

Optionally, the optimizing method optimizes the computational performance of the parameter servers, and the specific optimization method is as follows. Using the dataset size of each parameter server as the dependent variable and the working time and idle waiting time of each parameter server as the fitness function values, evaluate the performance of each parameter server. Based on the performance evaluation results, use an adaptive genetic algorithm to optimize the workload of each parameter server. This avoids human debugging to obtain the optimal solution, reduces the idle waiting time of the parameter server, increases the dataset size of the parameter server, and thus fully utilizes its computational performance.

The embodiment is merely a special case and does not indicate that the invention is implemented in this way only.

### Embodiment 2

An AI accelerator, obtained through the optimizing method of the AI accelerator in Embodiment 1. The AI accelerator, through the coding capability of genetic programming, solves the problems of unexplainability and incomprehensibility of neural network generation in AI accelerators. At the same time, it utilizes the optimization performance of genetic programming as an evolutionary algorithm to effectively reduce the computational time in AI accelerators. In the search space of different weight accuracies and feature accuracies in each layer, it searches for an optimal neural network architecture with weight accuracy and feature accuracy, reducing the computational cost of the AI accelerator.

The above only illustrates some of the preferred embodiments of the present invention. Artisans of the field may appreciate that various changes and equivalent substitutes can be made on the features and embodiments without departing from the spirit and scope of the present invention. Further, with the teaching of the present invention, such features and embodiments can be modified to adapt to specific situations and materials without departing the spirit and scope of the present invention. Thus, the present invention is not limited to the specific embodiments disclosed herein and all the embodiments that fall in the scope of the claims of the application should be considered belonging to the scope of protection of the present invention.

What is claimed is:

1. An optimizing method for an AI accelerator, characterized by optimizing the AI accelerator through obtaining target neural network architecture by genetic programming, including the following steps:
S10, preparing required raw data based on a target problem, removing abnormal data from the raw data, annotating based on different data types to obtain annotated data, and selecting part of the annotated data as a training set;
S20, determining search space of genetic programming, defining function set and terminal set of genetic programming, and performing preprocessing, extracting features, concatenating features, regressing and result outputting on the annotated data;
S30, defining fitness function used in genetic programming to search for optimal individuals; and
S40, based on the function set, terminal set, and fitness function, the training set performing population initialization, fitness evaluation, genetic operation execution, and genetic termination condition judgment, to search for obtaining the target neural network architecture;
wherein in the step S20, the genetic programming employs a tree structure for neural network architecture search, the tree structure defines input and output of each layer in the genetic programming, and defines order of different layers, input and output relationships between different layers, and overall input and output formats in the neural network architecture; the function set includes different functional layers of the tree structure, each corresponding to a different function and including a preset number of unit; and the terminal set defines parameters of different functional layers, ensuring that the input and output types of each functional layer match each other and meet algorithm requirements of the genetic programming; and
wherein the genetic programming performs elite selection and acquired inheritance based on the fitness of each individual.

2. The optimizing method for the AI accelerator according to claim 1, wherein the functional layer includes an input layer, a preprocessing layer, a feature extraction layer, a feature concatenation layer, and an output layer; the input layer is used to input raw data, the preprocessing layer is used to preprocess the type of the raw data, the feature extraction layer extracts features of the raw data through a feature extraction network, the feature concatenation layer is used to concatenate different features extracted by the feature extraction layer, and the output layer returns output results based on the features extracted by the feature extraction layer.

3. The optimizing method for the AI accelerator according to claim 1, wherein the step S40 comprises the following steps:
S41, randomly generating an initial population consisting of multiple individuals based on the search space, the function set, and the terminal set, and using the fitness function to evaluate each individual;
S42, performing two genetic operations including rewrite and mutation on each individual in the initial population, and to obtain a new population for a next generation, evaluating each individual in a new population using the fitness function;
S43, determining whether the new population satisfies the genetic termination condition; if so, executing S44; otherwise, executing S42; and
S44, terminating evolutionary learning process, returning a best individual as the optimal result of the search, and obtaining the target neural network architecture.

4. The optimizing method for the AI accelerator according to claim 1, wherein the optimizing method is based on GPU computation, and comprises the following steps:
S100, letting gen=0;
S200, generating the initial population X_{gen}={x₁, x₂, . . . , xₙ} on the GPU using “curand” command;
S300, gen=gen+1;
S400, conducting a neural network simulation for each generated individual and calculating the fitness F_{gen}={f₁, f₂, . . . , fₙ};
S500, waiting for all threads to synchronize, and performing genetic programming operations based on the fitness of each individual;
S600, selecting a neural network with the highest fitness, training it using BP backpropagation and Adam optimizer, and obtaining Chromₑₗᵢₜₑ;
S700, the generated threads performing genetic programming operations on the population to obtain the population X′;
S800, inserting Chromₑₗᵢₜₑ to X′ to obtain a new population X′_{gen}; and
S900, returning to step S300 until meeting the genetic termination condition, and outputting the neural network with the highest fitness as the target neural network architecture.

5. The optimizing method for the AI accelerator according to claim 1, wherein the optimizing method uses a tree-like parameter server structure for parameter aggregation, each parameter server receives parameters of its child nodes and performs aggregation the tree-like parameter server structure; when all the data is aggregated to a root node, the root node performs gradient descent operation and updates model parameters of the target neural network architecture; and the updated model parameters are distributed to each parameter server.

6. The optimizing method for the AI accelerator according to claim 5, wherein the optimizing method further optimizes dataset size and batch size of the target neural network architecture, and comprises the following steps:
S1000, each working node calculating dataset processing efficiency coefficient pᵢ^{j} based on its own computation time and uploading to a parameter server that serves as its parent node;
S2000, each parameter server calculating the sum of values of pᵢ^{j} uploaded by its child nodes until the root node completing the calculation;
S3000, the root node sums the processing efficiency coefficients pᵢ^{j} for each dataset to obtain the dataset processing efficiency parameter Σᵢ₌₁ⁿpᵢ^{j} and distribute it to its child nodes layer by layer, and calculating a dataset starting point for each child node; and the child nodes of the root node performing the same operation until the parameter servers at each layer completing the corresponding operation; and
S4000, each parameter server receiving the dataset starting point of the next round and dataset processing efficiency parameter Σᵢ₌₁ⁿpᵢ^{j}, calculating the batch size bᵢ^{j+1}=pᵢ^{j}/Σᵢ₌₁ⁿpᵢ^{j} and an end point of the dataset; wherein dᵢ^{j} is the proportion of the dataset size of the parameter server i in the jth round of training, bᵢ^{j} is the proportion of the batch size of the parameter server i in the jth round of training, tᵢ^{j} is the time of the parameter server i in the jth round of training, pᵢ^{j}=dᵢ^{j}/tᵢ^{j}, and pᵢ^{j} is the defined dataset processing efficiency coefficient.

7. The optimizing method for the AI accelerator according to claim 6, wherein the optimizing method optimizes the computational performance of the parameter servers, and the optimizing method comprises: taking the dataset size of each parameter server as the dependent variable, the working time and idle waiting time of each parameter server as the fitness function value, evaluating the performance of each parameter server, and optimizing the workload of each parameter server based on the performance evaluation results using an acquired genetic algorithm.

8. An AI accelerator, characterized in that the AI accelerator is obtained by the optimizing method for the AI accelerator according to claim 1.
